(19) United States
(12) Patent Application Publication
(10) Pub. No.: US 2026/0331550 A1
(43) Pub. Date: Oct. 22, 2026

(54) Method of Manufacturing Fuel Cell Stack and Fuel Cell Stack

(71) Applicant: HONDA MOTOR CO., LTD., TOKYO (JP)

(72) Inventor: Kazuo Nunokawa, WAKO-SHI (JP)

(21) Appl. No.: 19/467,980

(22) Filed: Feb. 3, 2026

(30) Foreign Application Priority Data
Feb. 5, 2025 (JP) 2025-017411

(51) Int. Cl. H01M 8/2404; H01M 8/0206; H01M 8/0273; H01M 8/0282; H01M 8/0284; H01M 8/0286; H01M 8/242

(52) U.S. Cl. CPC H01M 8/2404; H01M 8/0206; H01M 8/0273; H01M 8/0282; H01M 8/0284; H01M 8/0286; H01M 8/242

(57) ABSTRACT

A method of generating a fuel cell stack includes a first manufacturing step of manufacturing a plurality of resin framed membrane electrode assemblies each of which is provided with a resin seal member that is extended linearly on both surfaces of a resin frame member, a second manufacturing step of manufacturing a plurality of metal separators, and a stacking step of stacking the plurality of resin framed membrane electrode assemblies that are manufactured by the first manufacturing step and the plurality of metal separators that are manufactured by the second manufacturing step, in a manner so that end surfaces in a protruding direction of metal seal members are in contact with the resin seal member.

### CROSS-REFERENCE TO RELATED APPLICATIONS

This application is based upon and claims the benefit of priority from Japanese Patent Application No. 2025-017411 filed on Feb. 5, 2025, the contents of which are incorporated herein by reference.

### BACKGROUND OF THE INVENTION

### Field of the Invention

The present disclosure relates to a method of manufacturing a fuel cell stack and a fuel cell stack.

### Description of the Related Art

In recent years, there has been research and development on a method of manufacturing a fuel stack that contributes to energy efficiency in order to ensure that more people have access to affordable, reliable, sustainable and modern energy.

For example, in JP 2022-015866 A, there is described a method for manufacturing a separator with an integrated seal, in which a sealing material is applied to the surface of a separator of a fuel cell and then the sealing material is fired to form a seal member. In such a method of manufacturing a separator with an integrated seal, a masking jig is used in a manner so that outgassing generated at a time when the sealing material is fired does not adhere to flow paths of the separator.

### SUMMARY OF THE INVENTION

There is a long-awaited need for a more satisfactory method of manufacturing a fuel cell stack, and a fuel cell stack manufactured in accordance with such a method.

The present invention has the object of solving the aforementioned problem.

A first aspect of the present disclosure is characterized by a method of manufacturing a fuel cell stack equipped with a cell stack body in which a plurality of electrical power generating cells are stacked mutually on one another, the electrical power generating cells comprising a resin framed membrane electrode assembly comprising a membrane electrode assembly in which electrodes are joined to both surfaces of an electrolyte membrane, and a resin frame member disposed on an outer peripheral part of the membrane electrode assembly in a manner so as to project outwardly from the outer peripheral part of the membrane electrode assembly, and a pair of metal separators disposed on both sides of the resin framed membrane electrode assembly and formed in a plate-like shape, wherein each of the pair of metal separators comprises a metal seal member configured to extend linearly together with projecting out toward the resin frame member, and further, to elastically deform by a clamping load being applied in a stacking direction to the cell stack body, the method of manufacturing the fuel cell stack comprising a first manufacturing step of manufacturing a plurality of the resin framed membrane electrode assemblies each of which is provided with a resin seal member configured to be extended linearly on both sides of the resin frame member, a second manufacturing step of manufacturing a plurality of the metal separators, and a stacking step of stacking the plurality of resin framed membrane electrode assemblies that are manufactured by the first manufacturing step and the plurality of metal separators that are manufactured by the second manufacturing step, in a manner so that end surfaces in a protruding direction of the metal seal member are in contact with the resin seal member.

A second aspect of the present disclosure is characterized by method of manufacturing a fuel cell stack, the fuel cell stack comprising a cell stack body in which a plurality of electrical power generating cells are stacked mutually on one another, each of the electrical power generating cells comprising a membrane electrode assembly in which electrodes are joined to both surfaces of an electrolyte membrane, and a pair of metal separators disposed on both sides of the membrane electrode assembly and formed in a plate-like shape, and a pair of insulating plates disposed on both sides in a stacking direction of the cell stack body, wherein each of a pair of end part metal separators, which are the pair of metal separators positioned at both ends in the stacking direction of the cell stack body, comprises a metal seal member configured to extend linearly together with projecting out toward the insulating plates, and further, to elastically deform by a clamping load being applied in the stacking direction to the cell stack body, the method of manufacturing the fuel cell stack comprising a preparatory step of preparing the pair of insulating plates each of which is provided with an end part resin seal member configured to be extended linearly, and a stacking step of mutually stacking the pair of insulating plates and the pair of end part metal separators, in a manner so that end surfaces in a protruding direction of the metal seal member of the end part metal separators are in contact with the end part resin seal member.

A third aspect of the present disclosure is characterized by a fuel cell stack equipped with a cell stack body in which a plurality of electrical power generating cells are stacked mutually on one another, the electrical power generating cells comprising a resin framed membrane electrode assembly comprising a membrane electrode assembly in which electrodes are joined to both surfaces of an electrolyte membrane, and a resin frame member disposed on an outer peripheral part of the membrane electrode assembly in a manner so as to project outwardly from the outer peripheral part of the membrane electrode assembly, and a pair of metal separators disposed on both sides of the resin framed membrane electrode assembly and formed in a plate-like shape, wherein each of the pair of metal separators comprises a metal seal member configured to extend linearly together with projecting out toward the resin frame member, and further, to elastically deform by a clamping load being applied in a stacking direction to the cell stack body, the resin framed membrane electrode assembly comprises a resin seal member provided on both sides of the resin frame member, and configured to be extended linearly together with being in contact with end surfaces in a protruding direction of the metal seal member, and a dimension in a widthwise direction of the resin seal member is greater than an interval between base portions of the metal seal member.

A fourth aspect of the present disclosure is characterized by a fuel cell stack comprising a cell stack body in which there are stacked mutually on one another a plurality of electrical power generating cells, each of which is equipped with a membrane electrode assembly in which electrodes are joined to both surfaces of an electrolyte membrane, and a pair of metal separators disposed on both sides of the membrane electrode assembly and formed in a plate-like shape, and a pair of insulating plates disposed on both sides in a stacking direction of the cell stack body, wherein an end part metal separator, which is the metal separator positioned on an end part in the stacking direction of the cell stack body, comprises a metal sealing portion that extends linearly together with projecting out toward the insulating plates, and further, undergoes elastic deformation by a clamping load being applied in the stacking direction to the cell stack body, a linearly extended end part resin seal member is provided on a surface facing toward the cell stack body from within the pair of insulating plates, the pair of insulating plates sandwich the cell stack body in a manner so that the end surface in a protruding direction of the metal seal member of the end part metal separator contacts the end part resin seal member, and a dimension in a widthwise direction of the end part resin seal member is greater than an interval between base portions of the metal seal member of the end part metal separator.

According to the present disclosure, a more satisfactory method of manufacturing a fuel cell stack, and a fuel cell stack manufactured in accordance with such a method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic cross-sectional view of a fuel cell stack;

FIG. 2 is a cross-sectional view with partial omission taken along line II-II of FIG. 1;

FIG. 3 is a cross-sectional view with partial omission taken along line III-III of FIG. 1;

FIG. 4 is an exploded perspective view with partial omission of a cell stack body;

FIG. 5 is a plan view of a joined separator as viewed from a side of a first metal separator;

FIG. 6 is an enlarged cross-sectional view of a portion of FIG. 2;

FIG. 7 is a plan view of the joined separator as viewed from a side of a second metal separator;

FIG. 8 is a plan view of a resin framed membrane electrode assembly as viewed from one side;

FIG. 9 is a plan view of the resin framed membrane electrode assembly as viewed from another side;

FIG. 10 is a plan view of one insulating plate;

FIG. 11 is a plan view of another insulating plate;

FIG. 12 is a flowchart illustrating a method of manufacturing the fuel cell stack;

FIG. 13A and FIG. 13B are flowcharts illustrating a method of manufacturing the fuel cell stack;

FIG. 14 is a schematic explanatory diagram of a first manufacturing step;

FIG. 15 is a schematic explanatory diagram of a joining step; and

FIG. 16A is a cross-sectional view of a fuel cell stack according to a comparative example, and FIG. 16B is a cross-sectional view illustrating the fuel cell stack according to the present embodiment.

### DETAILED DESCRIPTION OF THE INVENTION

In the method of manufacturing the separator with an integrated seal described in JP 2022-015866 A, it is necessary to prepare a mask jig, and an operation of attaching and detaching the mask jig with respect to a separator takes place. The present disclosure is capable of providing a method of manufacturing a fuel cell stack and a fuel cell stack in which manufacturing costs can be reduced.

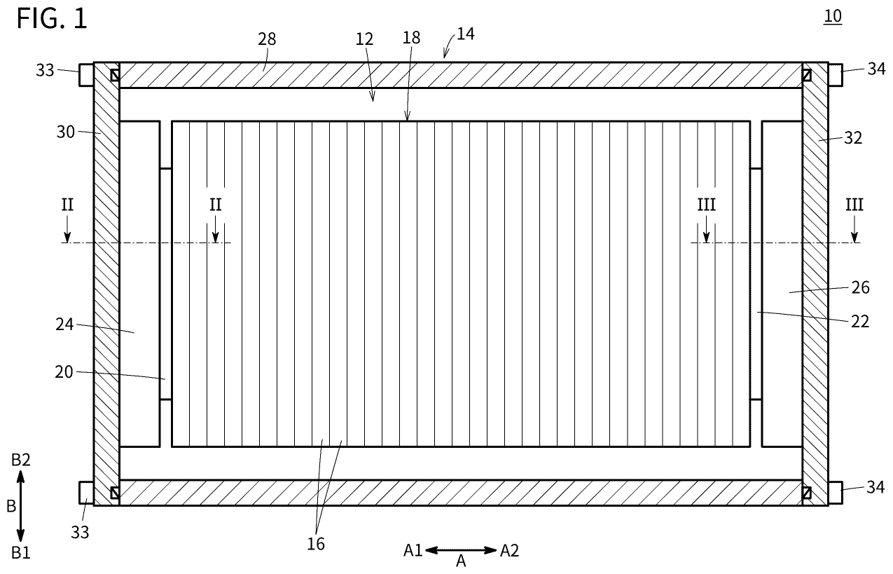

A description will be given below with reference to the drawings concerning a method of manufacturing a fuel cell stack 10 and the fuel cell stack 10 according to an embodiment of the present disclosure. FIG. 1 is a schematic cross-sectional view of the fuel cell stack 10.

The fuel cell stack 10 shown in FIG. 1 is mounted, for example, on a non-illustrated fuel cell vehicle. Moreover, the fuel cell stack 10 may be mounted on equipment other than a vehicle. The fuel cell stack 10 may be used as a stationary electrical power source.

As shown in FIG. 1, the fuel cell stack 10 is equipped with a stack main body 12 and a case unit 14. The stack main body 12 includes a cell stack body 18 in which a plurality of electrical power generating cells 16 are stacked mutually on one another, a pair of terminal plates 20 and 22, and a pair of insulating plates 24 and 26.

The electrical power generating cells 16 generate electrical power by means of an electrochemical reaction between an oxygen containing gas and a fuel gas. The oxygen containing gas is a gas that contains oxygen. As the oxygen containing gas, for example, air may be used. As the fuel gas, for example, hydrogen gas may be used. The fuel cell stack 10 is disposed, for example, in a manner so that a stacking direction (an A direction) of the cell stack body 18 is aligned with a horizontal direction. The fuel cell stack 10 may be disposed in a manner so that the stacking direction of the cell stack body 18 is aligned with the direction of gravity.

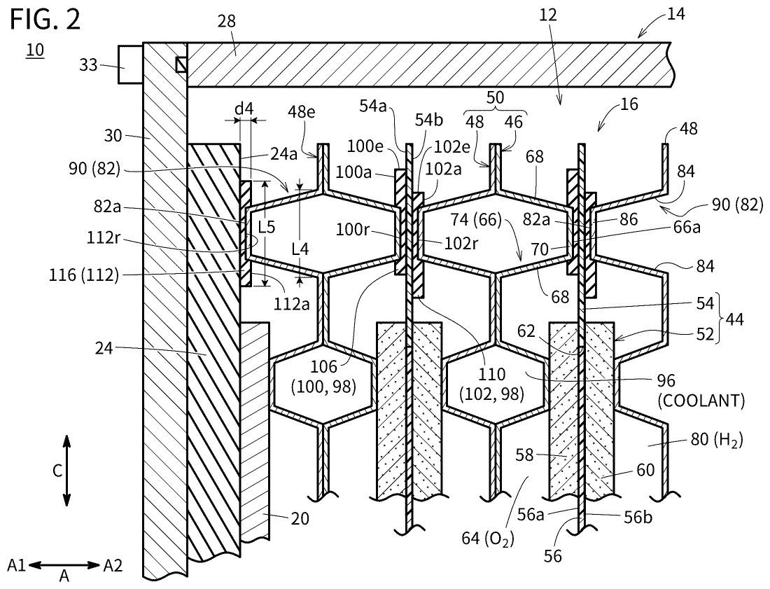

FIG. 2 is a cross-sectional view with partial omission taken along line II-II of FIG. 1. As shown in FIG. 1 and FIG. 2, the terminal plate 20 is disposed at one end (an end in the A1 direction) in the stacking direction of the cell stack body 18. The insulating plate 24 is disposed to be adjacent in the A1 direction with respect to the terminal plate 20.

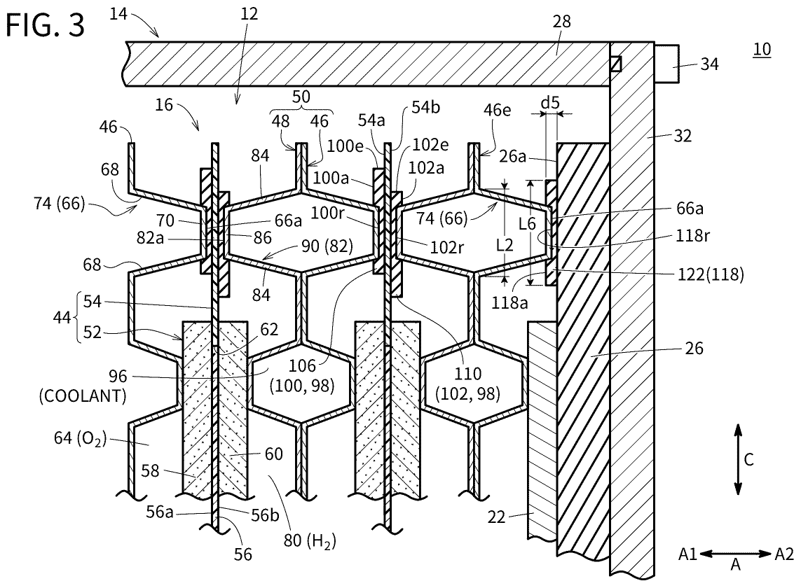

FIG. 3 is a cross-sectional view with partial omission taken along line III-III of FIG. 1. As shown in FIG. 1 and FIG. 3, the terminal plate 22 is disposed at another end (an end in the A2 direction) in the stacking direction of the cell stack body 18. The other insulating plate 26 is disposed to be adjacent in the A2 direction with respect to the terminal plate 22.

In FIG. 1 to FIG. 3, each of the terminal plates 20 and 22 is formed, for example, in a rectangular shape (a quadrilateral shape) from a conductive metal material. The terminal plates 20 and 22 are plates for the purpose of extracting to the exterior the electrical power generated by the cell stack body 18 (the plurality of electrical power generating cells 16). Each of the insulating plates 24 and 26 is formed, for example, in a rectangular shape (a quadrilateral shape) from an electrically insulating resin material.

As shown in FIG. 1, the case unit 14 includes a tubular shaped peripheral wall case 28, and a pair of end plates 30 and 32. The end plate 30 is joined by a plurality of bolts 33 with respect to the peripheral wall case 28, in a manner so as to close an opening portion in the A1 direction of the peripheral wall case 28. The insulating plate 24 (refer to FIG. 2) is in contact with the end plate 30.

The end plate 32 is joined by a plurality of bolts 34 with respect to the peripheral wall case 28, in a manner so as to close an opening portion in the A2 direction of the peripheral wall case 28. The insulating plate 26 (refer to FIG. 3) is in contact with the end plate 32. By fastening the end plate 32 to the peripheral wall case 28 by the bolts 34, the cell stack body 18 is sandwiched between the pair of insulating plates 24 and 26. More specifically, a clamping load in the stacking direction is applied to the cell stack body 18.

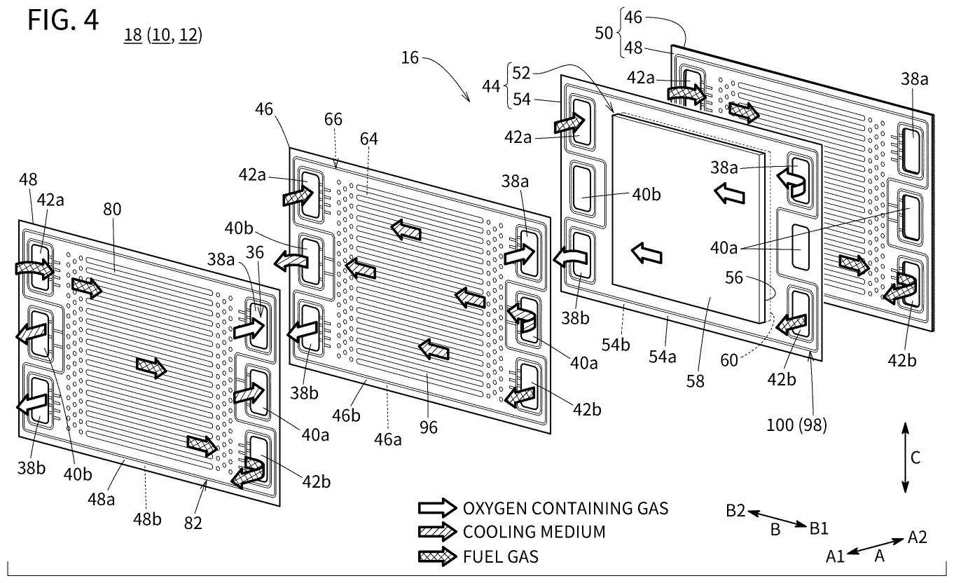

FIG. 4 is an exploded perspective view with partial omission of the cell stack body 18. As shown in FIG. 4, the electrical power generating cell 16 includes a horizontally elongate rectangular shape. The size, shape, and the like of the electrical power generating cell 16 can be set as appropriate.

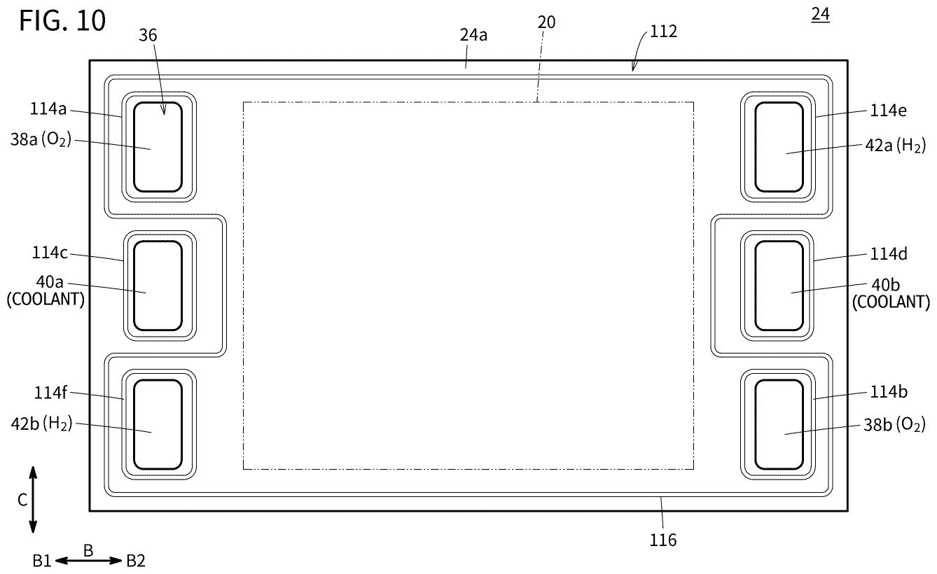

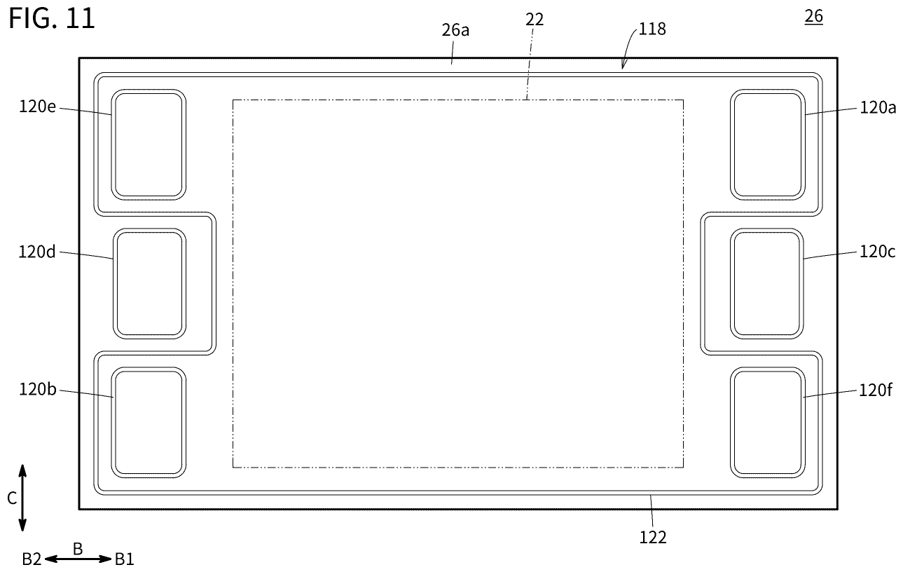

A plurality of communication holes 36 are formed to penetrate through each of the electrical power generating cells 16 in order to allow a fluid to flow therethrough in the stacking direction of the cell stack body 18. The plurality of communication holes 36 are also formed to penetrate through the insulating plate 24 and the end plate 30 (refer to FIG. 10). Moreover, it should be noted that the plurality of communication holes 36 are not formed in the insulating plate 26 and the end plate 32 (refer to FIG. 11).

The plurality of communication holes 36 include an oxygen containing gas supply communication hole 38a, an oxygen containing gas discharge communication hole 38b, a cooling medium supply communication hole 40a, a cooling medium discharge communication hole 40b, a fuel gas supply communication hole 42a, and a fuel gas discharge communication hole 42b.

At one end part in a longitudinal direction of the electrical power generating cell 16 (an end part in the B1 direction), the oxygen containing gas supply communication hole 38a, the cooling medium supply communication hole 40a, and the fuel gas discharge communication hole 42b are arranged along a lateral direction (a C direction) of the electrical power generating cell 16. At another end part in a longitudinal direction of the electrical power generating cell 16 (an end part in the B2 direction), the fuel gas supply communication hole 42a, the cooling medium discharge communication hole 40b, and the oxygen containing gas discharge communication hole 38b are arranged along the C direction.

The oxygen containing gas flows along the A2 direction through the oxygen containing gas supply communication hole 38a. The oxygen containing gas flows along the A1 direction through the oxygen containing gas discharge communication hole 38b. The cooling medium flows along the A2 direction through the cooling medium supply communication hole 40a. The cooling medium flows along the A1 direction through the cooling medium discharge communication hole 40b. The fuel gas flows along the A2 direction through the fuel gas supply communication hole 42a. The fuel gas flows along the A1 direction through the fuel gas discharge communication hole 42b.

The arrangement, the shape, and the size of the plurality of communication holes 36 can be set as appropriate.

As shown in FIG. 2 to FIG. 4, the electrical power generating cells 16 include a resin framed membrane electrode assembly 44, and a pair of metal separators 46 and 48 that are formed in a plate-like shape. Hereinafter, one metal separator 46 out of the pair of metal separators 46 and 48 may be referred to as a “first metal separator 46”, and the other metal separator 48 out of the pair of metal separators 46 and 48 may be referred to as a “second metal separator 48”. The first metal separator 46 and the second metal separator 48 form a joined separator 50 in which the metal separators are joined mutually to each other by a plurality of non-illustrated joining lines.

The resin framed membrane electrode assembly 44 includes a membrane electrode assembly (MEA) 52, and a resin frame member 54. The membrane electrode assembly 52 is formed by bonding electrodes 58 and 60 to both sides of an electrolyte membrane 56. Hereinafter, one electrode 58 out of the pair of electrodes 58 and 60 may be referred to as a “cathode electrode 58”, and the other electrode 60 out of the pair of electrodes 58 and 60 may be referred to as an “anode electrode 60”.

The electrolyte membrane 56, for example, is a solid polymer electrolyte membrane. Such a solid polymer electrolyte membrane, for example, is a thin membrane of perfluorosulfonic acid containing water. The electrolyte membrane 56 may be a fluorine-based electrolyte membrane.

As shown in FIG. 2 and FIG. 3, the cathode electrode 58 is joined to one surface 56a of the electrolyte membrane 56. The anode electrode 60 is joined to another surface 56b of the electrolyte membrane 56. The electrolyte membrane 56 is sandwiched between the cathode electrode 58 and the anode electrode 60. Although detailed illustration thereof is omitted, each of the electrodes 58 and 60 includes an electrode catalyst layer that is joined to the electrolyte membrane 56, and a gas diffusion layer that is stacked on the electrode catalyst layer.

As shown in FIG. 4, the resin frame member 54 is disposed on an outer peripheral part of the membrane electrode assembly 52, in a manner so as to project outwardly from the outer peripheral part of the membrane electrode assembly 52. The resin frame member 54 is formed in a rectangular ring-like shape. More specifically, in the resin frame member 54, a rectangular shaped through hole 62 is formed in a central part thereof (refer to FIG. 2 and FIG. 3). The resin frame member 54 is formed in a sheet-like shape. The plurality of communication holes 36 are formed in each of the resin frame member 54, the first metal separator 46, and the second metal separator 48.

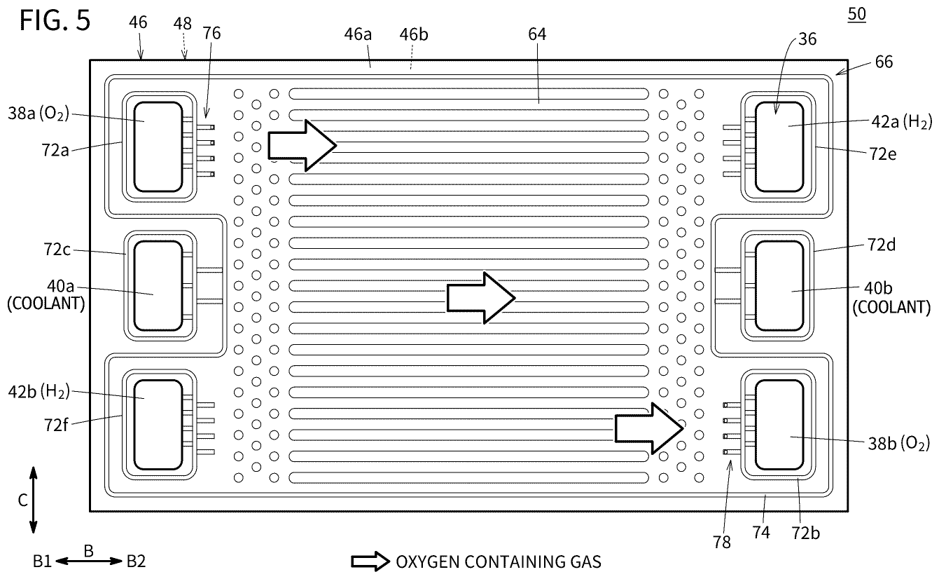

FIG. 5 is a plan view of the joined separator 50 as viewed from a side of the first metal separator 46. As shown in FIG. 5, an oxygen containing gas flow field 64 that extends in a B direction is formed on a surface (hereinafter referred to as a “surface 46a”) of the first metal separator 46 that faces toward the resin framed membrane electrode assembly 44. The oxygen containing gas flow field 64 is integrally formed with the first metal separator 46 by press molding (refer to FIG. 2 and FIG. 3). The oxygen containing gas flow field 64 communicates with the oxygen containing gas supply communication hole 38a and the oxygen containing gas discharge communication hole 38b. The oxygen containing gas flow field 64 supplies the oxygen containing gas to the cathode electrode 58 (electrical power generating region).

The first metal separator 46 comprises a metal seal member 66 (hereinafter referred to as a “first metal seal member 66”) that extends linearly in a state of also projecting out toward the resin frame member 54. The first metal seal member 66 prevents the reactive gases (the oxygen containing gas and the fuel gas) and the cooling medium from leaking to the exterior. The first metal seal member 66 is integrally formed together with the first metal separator 46 by press molding.

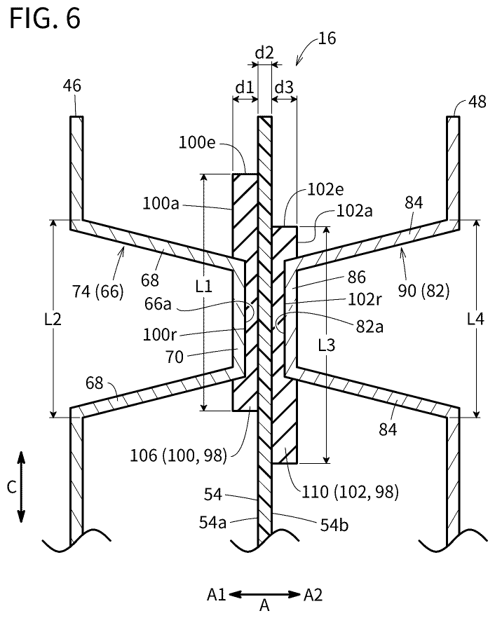

FIG. 6 is an enlarged cross-sectional view of a portion of FIG. 2. As shown in FIG. 6, the first metal seal member 66 is formed in a trapezoidal shape that tapers toward a protruding direction in which the first metal seal member 66 protrudes. The first metal seal member 66 undergoes elastic deformation by means of a clamping load being applied in the stacking direction to the cell stack body 18. The first metal seal member 66 includes a pair of first seal side portions 68, and a first seal top portion 70.

The pair of first seal side portions 68 are positioned in a manner so as to face toward (i.e., be opposite to) each other. An interval between the pair of first seal side portions 68 gradually narrows toward the first seal top portion 70. The first seal top portion 70 connects the ends in the protruding direction of the pair of first seal side portions 68. An end surface 66a in the protruding direction of the first metal seal member 66 is flat.

As shown in FIG. 5, the first metal seal member 66 includes a plurality of first communication hole seal members 72a to 72f, and one first flow path seal member 74. The first communication hole seal members 72a to 72f individually surround the plurality of communication holes 36.

Specifically, the first communication hole seal member 72a surrounds the oxygen containing gas supply communication hole 38a. The first communication hole seal member 72b surrounds the oxygen containing gas discharge communication hole 38b. The first communication hole seal member 72c surrounds the cooling medium supply communication hole 40a. The first communication hole seal member 72d surrounds the cooling medium discharge communication hole 40b. The first communication hole seal member 72e surrounds the fuel gas supply communication hole 42a. The first communication hole seal member 72f surrounds the fuel gas discharge communication hole 42b.

The plurality of first communication hole seal members 72a, 72b, 72e, and 72f are positioned on an inner side of the first flow path seal member 74. An oxygen containing gas supply tunnel 76 is provided in the first communication hole seal member 72a. The oxygen containing gas supply tunnel 76 connects the oxygen containing gas supply communication hole 38a and the oxygen containing gas flow field 64. An oxygen containing gas discharge tunnel 78 is provided in the first communication hole seal member 72b. The oxygen containing gas discharge tunnel 78 connects the oxygen containing gas discharge communication hole 38b and the oxygen containing gas flow field 64.

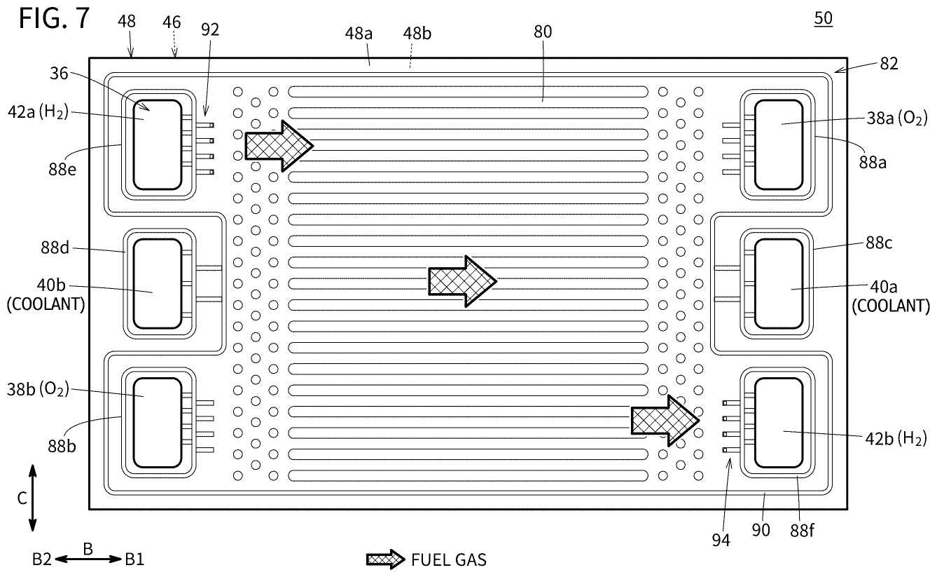

FIG. 7 is a plan view of the joined separator 50 as viewed from a side of the second metal separator 48. As shown in FIG. 7, a fuel gas flow field 80 that extends in the B direction is formed on a surface (hereinafter referred to as a “surface 48a”) of the second metal separator 48 that faces toward the resin framed membrane electrode assembly 44. The fuel gas flow field 80 is integrally formed with the second metal separator 48 by press molding (refer to FIG. 2 and FIG. 3). The fuel gas flow field 80 communicates with the fuel gas supply communication hole 42a and the fuel gas discharge communication hole 42b. The fuel gas flow field 80 supplies the fuel gas to the anode electrode 60 (the electrical power generating region).

The second metal separator 48 comprises a metal seal member 82 (hereinafter referred to as a “second metal seal member 82”) that extends linearly in a state of also projecting out toward the resin frame member 54. The second metal seal member 82 prevents the reactive gases (the oxygen containing gas and the fuel gas) and the cooling medium from leaking to the exterior. The second metal seal member 82 is integrally formed together with the second metal separator 48 by press molding.

As shown in FIG. 6, the second metal seal member 82 is formed in a trapezoidal shape that tapers toward a protruding direction in which the second metal seal member 82 protrudes. The second metal seal member 82 undergoes elastic deformation by means of a clamping load being applied in the stacking direction to the cell stack body 18. The second metal seal member 82 includes a pair of second seal side portions 84, and a second seal top portion 86.

The pair of second seal side portions 84 are positioned in a manner so as to face toward (i.e., be opposite to) each other. An interval between the pair of second seal side portions 84 gradually narrows toward the second seal top portion 86. The second seal top portion 86 connects the ends in the protruding direction of the pair of second seal side portions 84. An end surface 82a in the protruding direction of the second metal seal member 82 is flat.

As shown in FIG. 7, the second metal seal member 82 includes a plurality of second communication hole seal members 88a to 88f, and one second flow path seal member 90. The plurality of second communication hole seal members 88a to 88f individually surround the plurality of communication holes 36.

Specifically, the second communication hole seal member 88a surrounds the oxygen containing gas supply communication hole 38a. The second communication hole seal member 88b surrounds the oxygen containing gas discharge communication hole 38b. The second communication hole seal member 88c surrounds the cooling medium supply communication hole 40a. The second communication hole seal member 88d surrounds the cooling medium discharge communication hole 40b. The second communication hole seal member 88e surrounds the fuel gas supply communication hole 42a. The second communication hole seal member 88f surrounds the fuel gas discharge communication hole 42b.

The plurality of second communication hole seal members 88a, 88b, 88e, and 88f are positioned on an inner side of the second flow path seal member 90. A fuel gas supply tunnel 92 is provided in the second communication hole seal member 88e. The fuel gas supply tunnel 92 connects the fuel gas supply communication hole 42a and the fuel gas flow field 80. A fuel gas discharge tunnel 94 is provided in the second communication hole seal member 88f. The fuel gas discharge tunnel 94 connects the fuel gas discharge communication hole 42b and the fuel gas flow field 80.

As shown in FIG. 2 to FIG. 4, between a rear surface 46b of the first metal separator 46 and a rear surface 48b of the second metal separator 48, a cooling medium flow path 96 is formed that fluidly communicates with the cooling medium supply communication hole 40a and the cooling medium discharge communication hole 40b. The cooling medium flow path 96 is formed by overlapping a rear surface shape of the first metal separator 46 with which the oxygen containing gas flow field 64 is formed, and a rear surface shape of the second metal separator 48 with which the fuel gas flow field 80 is formed.

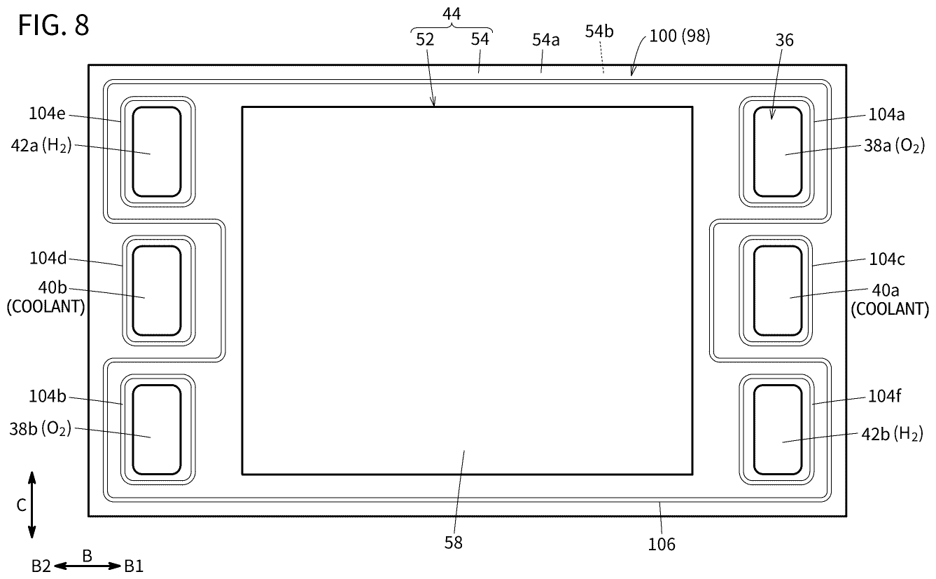

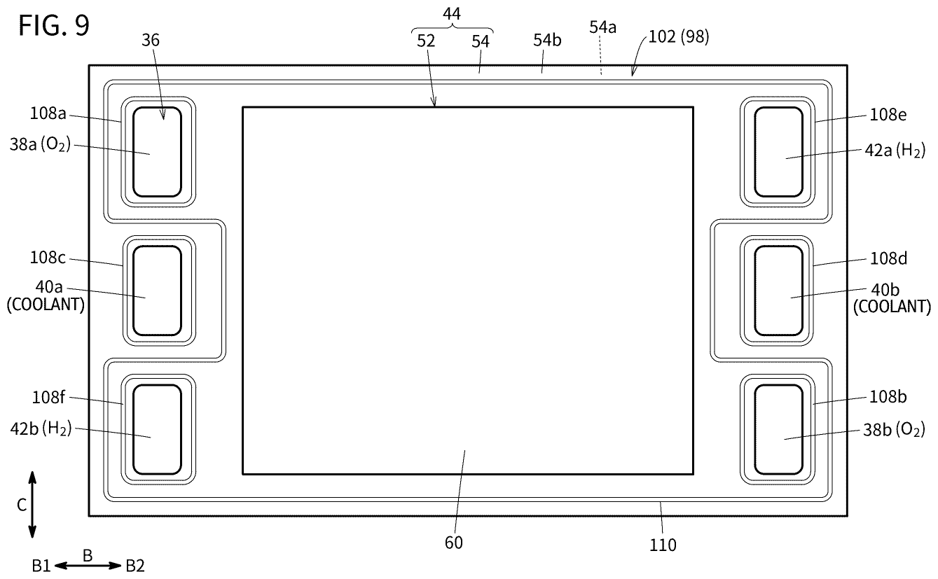

FIG. 8 is a plan view of the resin framed membrane electrode assembly 44 as viewed from one side. FIG. 9 is a plan view of the resin framed membrane electrode assembly 44 as viewed from another side. As shown in FIG. 8 and FIG. 9, a resin seal member 98 that extends linearly is disposed on both surfaces of the resin frame member 54. The resin seal member 98 is a thin film micro seal. The resin seal member 98 comprises a linear first resin seal member 100 provided on one surface 54a of the resin frame member 54, and a second resin seal member 102 provided on another surface 54b of the resin frame member 54.

As shown in FIG. 6, the first resin seal member 100 includes a flat surface 100a that faces toward the first metal separator 46. The end surface 66a in a protruding direction of the first metal seal member 66 is in airtight and liquidtight contact with the first resin seal member 100. A dimension L1 in a widthwise direction of the first resin seal member 100 is greater than an interval L2 between base portions of the first metal seal member 66. The widthwise direction of the first resin seal member 100 is a direction that is perpendicular to an extending direction of the first resin seal member 100 and a thickness direction of the first resin seal member 100.

The end surface 66a in the protruding direction of the first metal seal member 66 is pressed by the tightening load against the flat surface 100a of the first resin seal member 100. Therefore, a depression 100r corresponding to the first seal top portion 70 is formed on the flat surface 100a of the first resin seal member 100. A thickness d1 of a portion of the first resin seal member 100 where the flat surface 100a is not recessed is, for example, thicker than a thickness d2 of the resin frame member 54. The thickness d1 may be less than or equal to the thickness d2.

As shown in FIG. 8, the first resin seal member 100 comprises a plurality of first communication hole resin seal members 104a to 104f, and one first flow path resin seal member 106. The plurality of first communication hole resin seal members 104a to 104f individually surround the plurality of communication holes 36.

Specifically, the first communication hole resin seal member 104a surrounds the oxygen containing gas supply communication hole 38a. The first communication hole resin seal member 104b surrounds the oxygen containing gas discharge communication hole 38b. The first communication hole resin seal member 104c surrounds the cooling medium supply communication hole 40a. The first communication hole resin seal member 104d surrounds the cooling medium discharge communication hole 40b. The first communication hole resin seal member 104e surrounds the fuel gas supply communication hole 42a. The first communication hole resin seal member 104f surrounds the fuel gas discharge communication hole 42b. The plurality of first communication hole resin seal members 104a, 104b, 104e, and 104f are positioned on an inner side of the first flow path resin seal member 106.

The plurality of first communication hole resin seal members 104a to 104f contact the first communication hole seal members 72a to 72f of the first metal separator 46. The first flow path resin seal member 106 contacts the first flow path seal member 74 (refer to FIG. 6). In accordance with this feature, it is possible to prevent reactant gases (the oxygen containing gas and the fuel gas) and the cooling medium from leaking from between the resin framed membrane electrode assembly 44 and the first metal separator 46.

As shown in FIG. 9, the second resin seal member 102 is formed in a film shape. The second resin seal member 102 includes a flat surface 102a that faces toward the second metal separator 48.

As shown in FIG. 6, an end surface 82a in a protruding direction of the second metal seal member 82 is in airtight and liquidtight contact with the second resin seal member 102. A dimension L3 in a widthwise direction of the second resin seal member 102 is greater than an interval L4 between base portions of the second metal seal member 82. The widthwise direction of the second resin seal member 102 is a direction that is perpendicular to an extending direction of the second resin seal member 102 and a thickness direction of the second resin seal member 102.

The end surface 82a in the protruding direction of the second metal seal member 82 is pressed by the tightening load against the flat surface 102a of the second resin seal member 102. Therefore, a depression 102r corresponding to the second seal top portion 86 is formed on the flat surface 102a of the second resin seal member 102. A thickness d3 of a portion of the second resin seal member 102 where the flat surface 102a is not recessed is thicker than the thickness d2. The thickness d3 may be less than or equal to the thickness d2. The thickness d3 may be the same thickness as the thickness d1, or may be a different thickness from the thickness d1.

As shown in FIG. 9, the second resin seal member 102 comprises a plurality of second communication hole resin seal members 108a to 108f, and one second flow path resin seal member 110. The plurality of second communication hole resin seal members 108a to 108f individually surround the plurality of communication holes 36.

Specifically, the second communication hole resin seal member 108a surrounds the oxygen containing gas supply communication hole 38a. The second communication hole resin seal member 108b surrounds the oxygen containing gas discharge communication hole 38b. The second communication hole resin seal member 108c surrounds the cooling medium supply communication hole 40a. The second communication hole resin seal member 108d surrounds the cooling medium discharge communication hole 40b. The second communication hole resin seal member 108e surrounds the fuel gas supply communication hole 42a. The second communication hole resin seal member 108f surrounds the fuel gas discharge communication hole 42b. The plurality of second communication hole resin seal members 108a, 108b, 108e, and 108f are positioned on an inner side of the second flow path resin seal member 110.

The plurality of second communication hole resin seal members 108a to 108f contact the second communication hole seal members 88a to 88f of the second metal separator 48. The second flow path resin seal member 110 contacts the second flow path seal member 90 (refer to FIG. 6). In accordance with this feature, it is possible to prevent reactant gases (the oxygen containing gas and the fuel gas) and the cooling medium from leaking from between the resin framed membrane electrode assembly 44 and the second metal separator 48.

As shown in FIG. 6, FIG. 8, and FIG. 9, when viewed in a thickness direction of the resin frame member 54, the first resin seal member 100 and the second resin seal member 102 extend linearly in a state of mutually overlapping one another. Further, as shown in FIG. 6, a first end 100e, which is an end in the widthwise direction of the first resin seal member 100, is positioned to be offset in a planar direction of the resin frame member 54 with respect to a second end 102e, which is an end in the widthwise direction of the second resin seal member 102. More specifically, the first end 100e and the second end 102e do not overlap with each other in the stacking direction (the A direction) of the cell stack body 18.

In accordance with such a configuration, since the first end 100e of the first resin seal member 100 is positioned to be offset in the planar direction of the resin frame member 54 with respect to the second end 102e of the second resin seal member 102, a situation is suppressed in which stress concentrates at the end of the resin seal member 98 in a state in which the clamping load is applied to the cell stack body 18. In accordance therewith, it is possible to suppress damage or the like from occurring to the resin frame member 54.

FIG. 10 is a plan view of one insulating plate 24. As shown in FIG. 2 and FIG. 10, an end part resin seal member 112 (hereinafter referred to as a “first end part resin seal member 112”) is disposed on a surface 24a of the insulating plate 24 that faces toward the cell stack body 18. The first end part resin seal member 112 is a thin film micro seal.

As shown in FIG. 2, the first end part resin seal member 112 has a flat surface 112a that faces toward the cell stack body 18. The first end part resin seal member 112 is in airtight and liquidtight contact with the end surface 82a in the protruding direction of the second metal seal member 82 of the end part metal separator 48e, which is the metal separator 48 that is positioned at one end part (an end part in the A1 direction) of the cell stack body 18. Hereinafter, the end part metal separator 48e may be referred to as a “second end part metal separator 48e”.

A dimension L5 in the widthwise direction of the first end part resin seal member 112 is greater than an interval L4 between base portions of the second metal seal member 82 of the second end part metal separator 48e. The widthwise direction of the first end part resin seal member 112 is a direction that is perpendicular to an extending direction of the first end part resin seal member 112 and a thickness direction of the first end part resin seal member 112.

The end surface 82a in the protruding direction of the second metal seal member 82 of the second end part metal separator 48e is pressed by the tightening load against the flat surface 112a of the first end part resin seal member 112. Therefore, a depression 112r corresponding to the second seal top portion 86 is formed on the flat surface 112a of the first end part resin seal member 112. A thickness d4 of a portion of the first end part resin seal member 112 where the flat surface 112a is not recessed may be the same thickness as the thickness d1, or may be the same thickness as the thickness d3. The thickness d4 may be a thickness that is different from the thickness d1 and the thickness d3.

As shown in FIG. 10, the first end part resin seal member 112 comprises a plurality of first end part communication hole resin seal members 114a to 114f, and one first end part flow path resin seal member 116. The plurality of first end part communication hole resin seal members 114a to 114f individually surround the plurality of communication holes 36.

Specifically, the first end part communication hole resin seal member 114a surrounds the oxygen containing gas supply communication hole 38a. The first end part communication hole resin seal member 114b surrounds the oxygen containing gas discharge communication hole 38b. The first end part communication hole resin seal member 114c surrounds the cooling medium supply communication hole 40a. The first end part communication hole resin seal member 114d surrounds the cooling medium discharge communication hole 40b. The first end part communication hole resin seal member 114e surrounds the fuel gas supply communication hole 42a. The first end part communication hole resin seal member 114f surrounds the fuel gas discharge communication hole 42b. The plurality of first end part communication hole resin seal members 114a, 114b, 114e, and 114f are positioned on an inner side of the first end part flow path resin seal member 116.

The plurality of first end part communication hole resin seal members 114a to 114f contact the second communication hole seal members 88a to 88f of the second end part metal separator 48e. The first end part flow path resin seal member 116 contacts the second flow path seal member 90 of the second end part metal separator 48e (refer to FIG. 2). In accordance therewith, it is possible to prevent the reactant gases (the oxygen containing gas and the fuel gas) and the cooling medium from leaking from between the insulating plate 24 and the second end part metal separator 48e.

FIG. 11 is a plan view of another insulating plate 26. As shown in FIG. 3 and FIG. 11, an end part resin seal member 118 (hereinafter referred to as a “second end part resin seal member 118”) is disposed on a surface 26a of the insulating plate 26 that faces toward the cell stack body 18. The second end part resin seal member 118 is a thin film micro seal.

As shown in FIG. 3, the second end part resin seal member 118 has a flat surface 118a that faces toward the cell stack body 18. The second end part resin seal member 118 is in airtight and liquidtight contact with the end surface 66a in the protruding direction of the first metal seal member 66 of the end part metal separator 46e, which is the metal separator 46 that is positioned at the other end (an end in the A2 direction) of the cell stack body 18. Hereinafter, the end part metal separator 46e may be referred to as a “first end part metal separator 46e”.

A dimension L6 in the widthwise direction of the second end part resin seal member 118 is greater than an interval L2 between base portions of the first metal seal member 66 of the first end part metal separator 46e. The widthwise direction of the second end part resin seal member 118 is a direction that is perpendicular to an extending direction of the second end part resin seal member 118 and a thickness direction of the second end part resin seal member 118.

The end surface 66a in the protruding direction of the first metal seal member 66 of the first end part metal separator 46e is pressed by the tightening load against the flat surface 118a of the second end part resin seal member 118. Therefore, a depression 118r corresponding to the first seal top portion 70 is formed on the flat surface 118a of the second end part resin seal member 118. A thickness d5 of a portion of the second end resin seal member 118 where the flat surface 118a is not recessed is, for example, the same as the thickness d4. In other words, the thickness d5 may be the same thickness as the thickness d1, and may be the same thickness as the thickness d3. The thickness d5 may be a thickness that is different from the thickness d1 and the thickness d3. The thickness d5 may be a thickness that is different from the thickness d4.

As shown in FIG. 11, the second end part resin seal member 118 comprises a plurality of second end part communication hole resin seal members 120a to 120f, and one second end part flow path resin seal member 122.

The plurality of second end part communication hole resin seal members 120a to 120f contact the plurality of first communication hole seal members 72a to 72f of the first end part metal separator 46e. The second end part flow path resin seal member 122 contacts the first flow path seal member 74 of the first end part metal separator 46e (refer to FIG. 3). In accordance therewith, it is possible to prevent the reactant gases (the oxygen containing gas and the fuel gas) and the cooling medium from leaking from between the insulating plate 26 and the first end part metal separator 46e.

Next, a description will be given concerning the operations of the fuel cell stack 10.

In the case that the fuel cell stack 10 is operated (initiated), by a non-illustrated oxygen containing gas pump being driven, the oxygen containing gas is supplied to the oxygen containing gas supply communication hole 38a. As shown in FIG. 4, the oxygen containing gas that flows through the oxygen containing gas supply communication hole 38a is guided to the oxygen containing gas flow field 64 of each of the electrical power generating cells 16. The oxygen containing gas, by flowing along the B direction through the oxygen containing gas flow field 64, is supplied to the cathode electrode 58.

Further, by a non-illustrated injector being driven, the fuel gas is supplied to the fuel gas supply communication hole 42a. The fuel gas that flows through the fuel gas supply communication hole 42a is guided to the fuel gas flow field 80 of each of the electrical power generating cells 16. The fuel gas, by flowing along the B direction through the fuel gas flow field 80, is guided to the anode electrode 60.

In each of the membrane electrode assemblies 52, the oxygen containing gas that is supplied to the cathode electrode 58 and the fuel gas that is supplied to the anode electrode 60 are consumed by an electrochemical reaction, and generation of electrical power is carried out.

The oxygen containing exhaust gas that has flowed through the oxygen containing gas flow field 64 is discharged to the oxygen containing gas discharge communication hole 38b. The oxygen containing exhaust gas that flows through the oxygen containing gas discharge communication hole 38b flows in the A1 direction and is discharged to the exterior of the cell stack body 18.

The fuel exhaust gas that has flowed through the fuel gas flow field 80 is discharged to the fuel gas discharge communication hole 42b. The fuel exhaust gas that flows through the fuel gas discharge communication hole 42b flows in the A1 direction and is discharged to the exterior of the cell stack body 18.

Furthermore, in the case that the fuel cell stack 10 is initiated, by a non-illustrated cooling medium pump being driven, the cooling medium is supplied to the cooling medium flow path 96. The cooling medium that flows through the cooling medium supply communication hole 40a is, after having cooled the electrical power generating cells 16 by flowing through the cooling medium flow path 96 of each of the electrical power generating cells 16, guided to the cooling medium discharge communication hole 40b. The cooling medium that flows through the cooling medium discharge communication hole 40b flows in the A1 direction and is discharged to the exterior of the cell stack body 18.

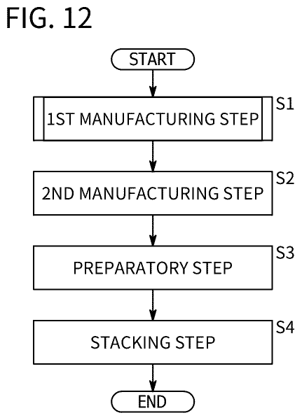

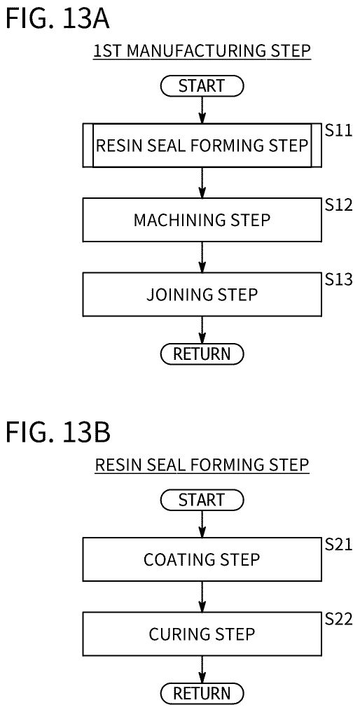

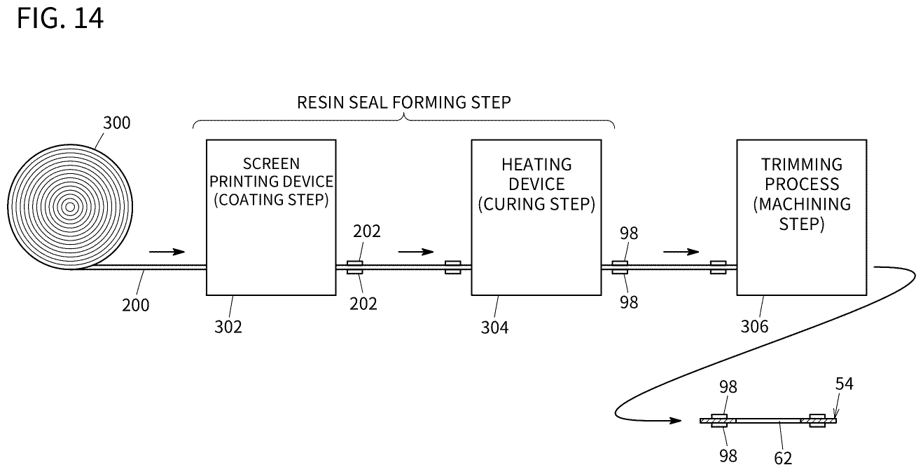

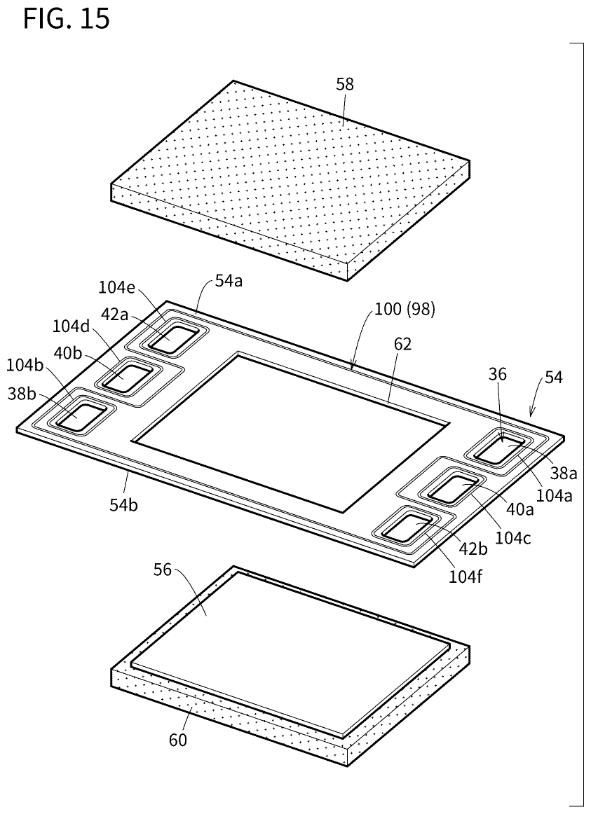

Next, a description will be given concerning the method of manufacturing the fuel cell stack 10. FIG. 12 to FIG. 13B are flowcharts illustrating the method of manufacturing the fuel cell stack 10. FIG. 14 is a schematic explanatory diagram of a first manufacturing step. FIG. 15 is a schematic explanatory diagram of a joining step.

As shown in FIG. 12, the method of manufacturing the fuel cell stack 10 includes a first manufacturing step, a second manufacturing step, a preparatory step, and a stacking step.

In step S1, the first manufacturing step is carried out. In the first manufacturing step, a plurality of the resin framed membrane electrode assemblies 44 are manufactured in which there are disposed the resin seal member 98 that is extended in a linear shape on both sides of the resin frame member 54. As shown in FIG. 13A, in the first manufacturing step, in step S11, a resin seal forming step of forming the resin seal member 98 on both sides of a resin sheet 200 is carried out.

More specifically, as shown in FIG. 13B, in the resin seal forming step, in step S21, a coating step of coating a sealing material 202 on both sides of the resin sheet 200 is carried out. In the present embodiment, in the case that the first manufacturing step is carried out, as shown in FIG. 14, the resin sheet 200 which is wound around an unwinding roll 300 is supplied to a screen printing device 302 in a roll-to-roll manner. Moreover, in the example of FIG. 14, conveying rollers and the like are not shown.

In the screen printing device 302, the sealing material 202 is applied by screen printing to both sides of the resin sheet 200 that is delivered out from the unwinding roll 300. The coating step is not limited to being performed by screen printing, and by any appropriate method, the sealing material 202 can be applied to both sides of the resin sheet 200.

In the coating step, the sealing material 202 is applied to both sides of the resin sheet 200 at the same time. Moreover, in the coating step, the sealing material 202 may be applied to one surface of the resin sheet 200, and thereafter, the sealing material 202 may be applied to the other surface of the resin sheet 200. The sealing material 202 that is applied to the resin sheet 200 by means of the coating step has a shape corresponding to the shape of the resin seal member 98.

Incidentally, in the case of providing the resin seal member 98 on the end surfaces 66a and 82a in the protruding direction of the metal seal members 66 and 82 of the metal separators 46 and 48, in the coating step, the metal seal members 66 and 82 must be positioned with high precision. Further, in a state in which a tightening load is not applied to the metal separators 46 and 48, the end surfaces 66a and 82a in the protruding direction of the metal seal members 66 and 82 are not flat but curved, and therefore, it is difficult to apply the sealing material 202. Furthermore, the width of the sealing material 202 is limited to being less than or equal to the width of the end surfaces 66a and 82a.

However, according to the present embodiment, in the coating step, in order to apply the sealing material 202 in a linear shape to the resin sheet 200, it is not necessary to position the resin sheet 200 with high precision with respect to the screen printing device 302 (the coating device). Further, since the sealing material 202 is coated on the flat planar surface of the resin sheet 200, the coating of the sealing material 202 is easy to perform. Furthermore, the widthwise dimension of the sealing material 202 is not limited to being the widthwise dimension of the end surfaces 66a and 82a in the protruding direction of the metal seal members 66 and 82. After the coating step, the process transitions to step S22.

In step S22, a curing step is carried out to obtain the resin seal member 98 by curing the sealing material 202. More specifically, the resin sheet 200, which is delivered from the screen printing device 302, is heated by a heating device 304. In this case, the sealing material 202 is cured and hardened by heat, and thereby the resin seal member 98 is obtained.

Stated otherwise, the first resin seal member 100 is obtained by curing the sealing material 202 that is coated on the one surface of the resin sheet 200. Further, the second resin seal member 102 is obtained by curing the sealing material 202 that is coated on the other surface of the resin sheet 200. Moreover, according to the present embodiment, the sealing material 202 is used, which becomes cured at a temperature that is less than or equal than a temperature at which the resin sheet 200 undergoes shrinking. In accordance with this feature, it is possible to obtain the resin seal member 98 while suppressing shrinkage of the resin sheet 200 due to heat.

Further, according to the present embodiment, since the resin seal forming step includes the coating step and the curing step, the resin seal member 98 can be efficiently formed on both surfaces of the resin frame member 54. Thereafter, the process transitions to step S12.

In step S12, by a trimming process being applied to the resin sheet 200 on which the resin seal member 98 has been formed, the resin frame member 54 on which the resin seal member 98 has been disposed is formed. More specifically, the resin sheet 200 that has been delivered from the heating device 304 is subjected to the trimming process by a machining device 306. Specifically, the machining device 306 cuts the resin sheet 200 to the same size as the outer shape of the resin frame member 54. Further, the machining device 306 also forms the through hole 62 and the plurality of communication holes 36 in the resin sheet 200. In accordance therewith, the resin frame member 54 on which the resin seal member 98 is provided can be obtained. Thereafter, the process transitions to step S13.

In step S13, a joining step is carried out in which the inner peripheral end part of the resin frame member 54 on which the resin seal member 98 is disposed is joined to the membrane electrode assembly 52. Specifically, as shown in FIG. 15, the electrolyte membrane 56, the cathode electrode 58, and the anode electrode 60 are prepared in advance. According to the present embodiment, the electrolyte membrane 56 is joined beforehand to the anode electrode 60. In the joining step, the inner peripheral edge part of the resin frame member 54 is sandwiched between the cathode electrode 58 and the anode electrode 60, in a manner so that the electrolyte membrane 56 is disposed in the through hole 62 of the resin frame member 54. The cathode electrode 58 and the anode electrode 60 are joined with respect to the resin frame member 54 with a non-illustrated adhesive. In accordance therewith, the resin framed membrane electrode assembly 44 is obtained. Moreover, it should be noted that the joining step is not necessarily limited to the above-described method.

According to the present embodiment, since the joining step is carried out after the coating step and the curing step, volatile components of the sealing material 202 do not adhere to the electrodes 58 and 60 and the like during the curing step. Therefore, during the curing step, there is no need to prepare a mask member or the like in order to protect the power generating region. Thus, the resin framed membrane electrode assembly 44 can be manufactured at a low cost.

Further, in step S2 of FIG. 12, the second manufacturing step to manufacture multiple pieces of the metal separators 46 and 48 is carried out. Specifically, multiple pieces of the joined separator 50 are manufactured by mutually joining the first metal separator 46 and the second metal separator 48 together in an overlapped state. The second manufacturing step may be carried out at the same time as the first manufacturing step.

Further, in step S3, the preparatory step of preparing the pair of insulating plates 24 and 26 on which the end part resin seal members 112 and 118 are linearly extended is carried out. Specifically, the insulating plate 24 on which the first end part resin seal member 112 is provided and the insulating plate 26 on which the second end part resin seal member 118 is provided are prepared. The first end part resin seal member 112 and the second end part resin seal member 118 can be formed by a method that is similar to the aforementioned resin seal forming step (screen printing) and the curing step. Further, the plurality of communication holes 36 of the insulating plate 24 can be formed by a method that is similar to the aforementioned machining step (the trimming process). The preparatory step may be carried out at the same time as the first manufacturing step and the second manufacturing step. Thereafter, the process transitions to step S4.

In step S4, the stacking step is carried out. Specifically, for example, at first, the end plate 30 is fastened by the bolts 33 to one end of the peripheral wall case 28. Next, on top of the end plate 30, the insulating plate 24, the terminal plate 20, the plurality of electrical power generating cells 16 (the cell stack body 18), the terminal plate 22, and the insulating plate 26 are stacked in this order inside the peripheral wall case 28. Thereafter, by the end plate 32 being fastened by the plurality of bolts 34 to the other end of the peripheral wall case 28, a clamping load is applied to the cell stack body 18. More specifically, the cell stack body 18 is sandwiched between the pair of insulating plates 24 and 26.

In the stacking step, a plurality of the resin framed membrane electrode assemblies 44 and a plurality of the joined separators 50 are stacked mutually on one another, in a manner so that the end surface 66a in the protruding direction of the first metal seal member 66 contacts the first resin seal member 100 together with the end surface 82a in the protruding direction of the second metal seal member 82 contacting the second resin seal member 102.

Further, in the stacking step, the insulating plate 24 and the second end part metal separator 48e are stacked in a manner so that the end surface 82a in the protruding direction of the second metal seal member 82 of the second end part metal separator 48e contacts the first end part resin seal member 112. Furthermore, in the stacking step, the first end part metal separator 46e and the insulating plate 26 are stacked in a manner so that the end surface 66a in the protruding direction of the first metal seal member 66 of the first end part metal separator 46e contacts the second end part resin seal member 118. In accordance therewith, the fuel cell stack 10 is manufactured. Thereafter, the process shown in FIG. 12 comes to an end.

Incidentally, in the fuel cell stack 10, in the stacking step, due to manufacturing tolerances and assembly tolerances and the like of the joined separator 50, the first metal seal member 66 and the second metal seal member 82 may become misaligned in the planar direction. A description will be given concerning the sealing function in such a case.

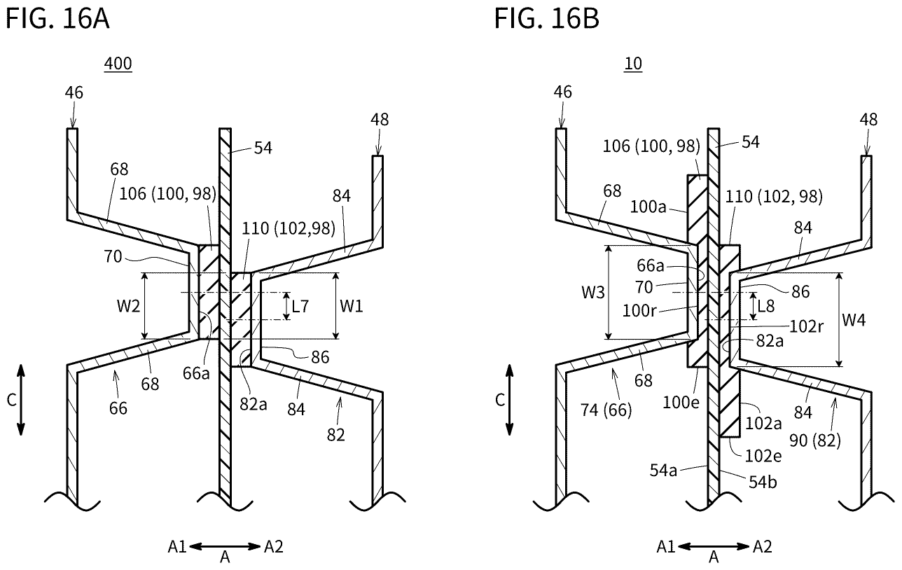

FIG. 16A is a cross-sectional view of a fuel cell stack 400 according to a comparative example. FIG. 16B is a cross-sectional view illustrating the fuel cell stack 10 according to the present embodiment. As shown in FIG. 16A, in the fuel cell stack 400 according to the comparative example, the first resin seal member 100 is fixed to the end surface 66a in the protruding direction of the first metal seal member 66 of the first metal separator 46, and the second resin seal member 102 is fixed to the end surface 82a in the protruding direction of the second metal seal member 82 of the second metal separator 48.

FIG. 16A shows an example, in the fuel cell stack 400 according to the comparative example, in which the first metal seal member 66 and the second metal seal member 82 with the resin frame member 54 in between are misaligned by a distance L7 in the planar direction. In this case, the first resin seal member 100 and the resin frame member 54 are sealed within the range of a seal width W1. The seal width W1 is smaller than the width of the end surface 66a in the protruding direction of the first metal seal member 66. Further, the second resin seal member 102 and the resin frame member 54 are sealed within the range of a seal width W2. The seal width W2 is smaller than the width of the end surface 82a in the protruding direction of the second metal seal member 82.

FIG. 16B shows an example, in the fuel cell stack 10 according to the present embodiment, in which the first metal seal member 66 and the second metal seal member 82 with the resin frame member 54 in between are misaligned by a distance L8 in the planar direction. The distance L8 is the same length as the distance L7. In this case, the first metal seal member 66 and the first resin seal member 100 are sealed within the range of a seal width W3. The seal width W3 is approximately the same as the width of the end surface 66a in the protruding direction of the first metal seal member 66, and is wider than the seal width W1. In this case, the second metal seal member 82 and the second resin seal member 102 are sealed within the range of a seal width W4. The seal width W4 is approximately the same as the width of the end surface 82a in the protruding direction of the second metal seal member 82, and is wider than the seal width W2. Further, one portion of the first metal seal member 66 (a portion including the first seal top portion 70) may be pressed (may be embedded) further toward the side of the resin frame member 54 than the flat surface 100a of the first resin seal member 100. In this case, the depression 100r corresponding to a part of the first metal seal member 66 is formed on the flat surface 100a of the first resin seal member 100. One portion of the second metal seal member 82 (a portion including the second seal top portion 86) may be pressed (may be embedded) further toward the side of the resin frame member 54 than the flat surface 102a of the second resin seal member 102. In this case, the depression 102r corresponding to a part of the second metal seal member 82 is formed on the flat surface 102a of the second resin seal member 102. Furthermore, the center in the widthwise direction of the first seal top portion 70 may be offset from the center in the widthwise direction of the first resin seal member 100. The center in the widthwise direction of the second seal top portion 86 may be offset from the center in the widthwise direction of the second resin seal member 102.

According to the present embodiment, it is possible to suppress a situation in which the seal width becomes narrower due to a misalignment in the planar direction between the first metal seal member 66 and the second metal seal member 82.

According to the present embodiment, since the resin seal member 98 is provided on the resin frame member 54 and not on the metal separators 46 and 48, there is no need to attach a mask member at a time during manufacturing of the metal separators 46 and 48. In accordance therewith, the manufacturing cost of the fuel cell stack 10 can be reduced.

Further, according to the present embodiment, since the resin seal member 98 is provided on the insulating plates 24 and 26 and not on the end part metal separators 46e and 48e, there is no need to attach a mask member at a time during manufacturing of the end part metal separators 46e and 48e. In accordance therewith, the manufacturing cost of the fuel cell stack 10 can be reduced.

According to the present embodiment, the machining step and the joining step are carried out after the resin seal member 98 has been formed on the resin sheet 200, and therefore, the resin seal member 98 can be easily provided on the resin frame member 54.

In the present embodiment, in a state in which the tightening load is applied to the cell stack body 18, the dimensions L1 and L3 in the width of the resin seal member 98 are greater than the intervals L2 and L4 between the base portions of the metal seal members 66 and 82. Therefore, during the stacking step, the metal seal members 66 and 82 can be easily brought into contact with the resin seal member 98. Stated otherwise, in the stacking step, the allowable amount of misalignment in the planar direction between the resin framed membrane electrode assembly 44 and the metal separators 46 and 48 can be made comparatively large. Accordingly, the stacking step can be easily carried out.

Further, in a state in which the tightening load is applied to the cell stack body 18, the dimensions L5 and L6 in the widthwise direction of the end part resin seal members 112 and 118 are greater than the intervals L2 and L4 between the base portions of the metal seal members 66 and 82. Therefore, during the stacking step, the metal seal members 66 and 82 can be easily brought into contact with the end part resin seal members 112 and 118. Stated otherwise, in the stacking step, the allowable amount of misalignment in the planar direction between the end part metal separators 46e and 48e and the insulating plates 24 and 26 can be made comparatively large. Accordingly, the stacking step can be easily carried out.

Concerning the above-described embodiment, the following supplementary notes are further disclosed.

### (Supplementary Note 1)

The method of manufacturing the fuel cell stack (10) according to the present disclosure is the method of manufacturing the fuel cell stack equipped with the cell stack body (18) in which the plurality of electrical power generating cells (16) are stacked mutually on one another, the electrical power generating cells comprising the resin framed membrane electrode assembly (44) comprising the membrane electrode assembly (52) in which the electrodes (58, 60) are bonded to both surfaces of the electrolyte membrane (56), and the resin frame member (54) disposed on the outer peripheral part of the membrane electrode assembly in a manner so as to project outwardly from the outer peripheral part of the membrane electrode assembly, and the pair of metal separators (46, 48) disposed on both sides of the resin framed membrane electrode assembly and formed in a plate-like shape, wherein each of the pair of metal separators comprises the metal seal members (66, 82) that extend linearly together with projecting out toward the resin frame member, and further, elastically deform by a clamping load being applied in the stacking direction to the cell stack body, the method of manufacturing the fuel cell stack comprising the first manufacturing step (S1) of manufacturing the plurality of resin framed membrane electrode assemblies each of which is provided with the resin seal member (98) configured to be extended linearly on both sides of the resin frame member, the second manufacturing step (S2) of manufacturing the plurality of metal separators, and the stacking step (S4) of stacking the plurality of resin framed membrane electrode assemblies that are manufactured by the first manufacturing step and the plurality of metal separators that are manufactured by the second manufacturing step, in a manner so that the end surfaces (66a, 82a) in the protruding direction of the metal seal members are in contact with the resin seal member.

In accordance with such a configuration, since the resin seal member is provided on the resin frame member and not on the metal separators, there is no need to attach a mask member at a time during manufacturing of the metal separators. In accordance therewith, the manufacturing cost of the fuel cell stack can be reduced.

### (Supplementary Note 2)

In the method of manufacturing the fuel cell stack according to Supplementary Note 1, the first manufacturing step may include the resin seal forming step (S11) of forming the resin seal member on both surfaces of the resin sheet (200), the machining step (S12) of forming the resin frame member on which the resin seal member is provided by trimming the resin sheet on which the resin seal member is formed, and the joining step (S13) of joining to the membrane electrode assembly the inner peripheral end part of the resin frame member on which the resin seal member is provided.

In accordance with such a configuration, the machining step and the joining step are carried out after the resin seal member has been formed on the resin sheet, and therefore, the resin seal member can be easily provided on the resin frame member.

### (Supplementary Note 3)

In the method of manufacturing the fuel cell stack according to Supplementary Note 2, the resin seal forming step may include the coating step (S21) of coating the sealing material (202) on both surfaces of the resin sheet, and after the coating step, the curing step (S22) of obtaining the resin seal member by curing the sealing material.

In accordance with such a configuration, the resin seal member can be efficiently formed on both surfaces of the resin frame member.

### (Supplementary Note 4)

In the method of manufacturing the fuel cell stack according to any one of Supplementary Notes 1 to 3, in a state in which the tightening load is applied to the cell stack body, the dimension (L1, L3) in the widthwise direction of the resin seal member may be greater than the interval (L2, L4) between the base portions of the metal seal members.

In accordance with such a configuration, during the stacking step, the metal seal members can be easily brought into contact with the resin seal member. Stated otherwise, in the stacking step, the allowable amount of misalignment in the planar direction between the resin framed membrane electrode assembly and the metal separators can be made comparatively large. Accordingly, the stacking step can be easily carried out.

### (Supplementary Note 5)

In the method of manufacturing the fuel cell stack according to any one of Supplementary Notes 1 to 4, the resin seal member may include the linear first resin seal member (100) that is provided on the one surface (54a) of the resin frame member, and the linear second resin seal member (102) that is provided on the other surface (54b) of the resin frame member, wherein, as viewed from the thickness direction of the resin frame member, together with the first resin seal member and the second resin seal member extending linearly in a state of mutually overlapping one another, the first end (100e), which is the end in the widthwise direction of the first resin seal member, is positioned to be offset in a planar direction of the resin frame member with respect to the second end (102e), which is the end in the widthwise direction of the second resin seal member.

In accordance with such a configuration, since the first end of the first resin seal member is positioned to be offset in the planar direction of the resin frame member with respect to the second end of the second resin seal member, a situation is suppressed in which stress concentrates at the end of the resin seal member in a state in which the clamping load is applied to the cell stack body. In accordance therewith, it is possible to suppress damage or the like from occurring to the resin frame member.

### (Supplementary Note 6)

In the method of manufacturing the fuel cell stack according to any one of Supplementary Notes 1 to 5, the fuel cell stack may comprise the pair of insulating plates (24, 26) that are disposed on both sides in the stacking direction of the cell stack body, and there may further be provided the preparatory step of preparing the pair of insulating plates each of which is provided with the end part resin seal member (112, 118) that extends linearly, wherein, in the stacking step, the pair of insulating plates and the cell stack body may be stacked mutually on one another, in a manner so that the end surface in the protruding direction of the metal seal member of the end part metal separator (46e, 48e), which is the metal separator that is positioned on the end part in the stacking direction of the cell stack body, contacts the end part resin seal member.

In accordance with such a configuration, since the end part resin seal member is provided on the insulating plate and not on the end part metal separator, there is no need to attach a mask member at a time during manufacturing of the end part metal separator. In accordance therewith, the manufacturing cost of the fuel cell stack can be reduced.

### (Supplementary Note 7)

In the method of manufacturing the fuel cell stack according to Supplementary Note 6, in a state in which the tightening load is applied to the cell stack body, the dimension (L5, L6) in the widthwise direction of the end part resin seal member may be greater than the interval between the base portions of the metal seal members.

In accordance with such a configuration, during the stacking step, the metal seal members can be easily brought into contact with the end part resin seal member. Stated otherwise, in the stacking step, the allowable amount of misalignment in the planar direction between the end part metal separator and the insulating plate can be made comparatively large. Accordingly, the stacking step can be easily carried out.

### (Supplementary Note 8)

The method of manufacturing the fuel cell stack according to the present disclosure is the method of manufacturing the fuel cell stack equipped with the cell stack body in which the plurality of electrical power generating cells are stacked mutually on one another, each of the electrical power generating cells comprising the membrane electrode assembly in which the electrodes are bonded to both surfaces of the electrolyte membrane, and the pair of metal separators disposed on both sides of the membrane electrode assembly and formed in a plate-like shape, and the pair of insulating plates disposed on both sides in a stacking direction of the cell stack body, wherein each of the pair of end part metal separators, which are the pair of metal separators positioned at both ends in the stacking direction of the cell stack body, comprises the metal seal member configured to extend linearly together with projecting out toward the insulating plates, and further, to elastically deform by the clamping load being applied in the stacking direction to the cell stack body, the method of manufacturing the fuel cell stack comprising the preparatory step of preparing the pair of insulating plates each of which is provided with the end part resin seal member configured to be extended linearly, and the stacking step of mutually stacking the pair of insulating plates and the pair of end part metal separators, in a manner so that the end surfaces in the protruding direction of the metal seal member of the end part metal separators are in contact with the end part resin seal member.

In accordance with such a configuration, since the resin seal member is provided on the insulating plate and not on the end part metal separator, there is no need to attach a mask member at a time during manufacturing of the end part metal separator. In accordance therewith, the manufacturing cost of the fuel cell stack can be reduced.

### (Supplementary Note 9)

The fuel cell stack according to the present disclosure is the fuel cell stack equipped with the cell stack body in which the plurality of electrical power generating cells are stacked mutually on one another, the electrical power generating cells comprising the resin framed membrane electrode assembly including the membrane electrode assembly in which the electrodes are bonded to both surfaces of the electrolyte membrane, and the resin frame member disposed on the outer peripheral part of the membrane electrode assembly in a manner so as to project outwardly from the outer peripheral part of the membrane electrode assembly, and the pair of metal separators disposed on both sides of the resin framed membrane electrode assembly and formed in a plate-like shape, wherein each of the pair of metal separators comprises the metal seal member that extends linearly together with projecting out toward the resin frame member, and further, that elastically deforms by the clamping load being applied in the stacking direction to the cell stack body, the resin framed membrane electrode assembly comprises the resin seal member provided on both sides of the resin frame member, and that extends linearly together with being in contact with the end surfaces in the protruding direction of the metal seal member, and the dimension in the widthwise direction of the resin seal member is greater than the interval between the base portions of the metal seal member.

In accordance with such a configuration, the same effects as those described in Supplementary Note 1 and Supplementary Note 4 can be achieved.

### (Supplementary Note 10)

The fuel cell stack according to the present disclosure is the fuel cell stack comprising the cell stack body in which there are stacked on one another the plurality of electrical power generating cells, each of which is equipped with the membrane electrode assembly in which the electrodes are bonded to both surfaces of the electrolyte membrane, and the pair of metal separators disposed on both sides of the membrane electrode assembly and formed in a plate-like shape, and the pair of insulating plates disposed on both sides in the stacking direction of the cell stack body, wherein the end part metal separator, which is the metal separator positioned on the end part in the stacking direction of the cell stack body, comprises the metal sealing portion that extends linearly together with projecting out toward the insulating plates, and further, undergoes elastic deformation by the clamping load being applied in the stacking direction to the cell stack body, the linearly extended end part resin seal member is provided on the surface facing toward the cell stack body from within the pair of insulating plates, the pair of insulating plates sandwich the cell stack body in a manner so that the end surface in the protruding direction of the metal seal member of the end part metal separator contacts the end part resin seal member, and the dimension in the widthwise direction of the end part resin seal member is greater than the interval between the base portions of the metal seal member of the end part metal separator.

In accordance with such a configuration, the same effects as those described in Supplementary Note 7 and Supplementary Note 8 can be achieved.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A method of manufacturing a fuel cell stack including a cell stack body in which a plurality of electrical power generating cells are stacked mutually on one another, the electrical power generating cells including:
a resin framed membrane electrode assembly including
a membrane electrode assembly in which electrodes are joined to both surfaces of an electrolyte membrane, and
a resin frame member disposed on an outer peripheral part of the membrane electrode assembly in a manner so as to project outwardly from the outer peripheral part of the membrane electrode assembly, and
a pair of metal separators disposed on both sides of the resin framed membrane electrode assembly and formed in a plate-like shape,
wherein each of the pair of metal separators includes a metal seal member configured to extend linearly together with projecting out toward the resin frame member, and to elastically deform by a clamping load being applied in a stacking direction to the cell stack body,
the method of manufacturing the fuel cell stack comprising:
a first manufacturing step of manufacturing a plurality of the resin framed membrane electrode assemblies each of which is provided with a resin seal member configured to be extended linearly on both sides of the resin frame member;
a second manufacturing step of manufacturing a plurality of the metal separators; and
a stacking step of stacking the plurality of resin framed membrane electrode assemblies that are manufactured in the first manufacturing step and the plurality of metal separators that are manufactured in the second manufacturing step mutually on one another, in a manner so that an end surface in a protruding direction of the metal seal member is in contact with the resin seal member.

2. The method of manufacturing the fuel cell stack according to claim 1, wherein the first manufacturing step includes:
a resin seal forming step of forming the resin seal member on both surfaces of a resin sheet;
a machining step of forming the resin frame member on which the resin seal member is provided by trimming the resin sheet on which the resin seal member is formed; and
a joining step of joining the membrane electrode assembly and an inner peripheral end part of the resin frame member on which the resin seal member is provided.

3. The method of manufacturing the fuel cell stack according to claim 2, wherein the resin seal forming step includes:
a coating step of coating a sealing material on both surfaces of the resin sheet; and
a curing step of obtaining the resin seal member by curing the sealing material after the coating step.

4. The method of manufacturing the fuel cell stack according to claim 1, wherein, in a state in which a tightening load is applied to the cell stack body, a dimension of the resin seal member in a widthwise direction of the resin seal member is greater than an interval between base portions of the metal seal member.

5. The method of manufacturing the fuel cell stack according to claim 1, the resin seal member including:
a linear first resin seal member configured to be provided on one surface of the resin frame member; and
a linear second resin seal member configured to be provided on another surface of the resin frame member,
wherein, as viewed from a thickness direction of the resin frame member, together with the first resin seal member and the second resin seal member extending linearly in a state of mutually overlapping one another, a first end, which is an end in a widthwise direction of the first resin seal member, is positioned to be offset in a planar direction of the resin frame member with respect to a second end, which is an end in a widthwise direction of the second resin seal member.

6. The method of manufacturing the fuel cell stack according to claim 1, wherein the fuel cell stack includes a pair of insulating plates arranged on both sides in the stacking direction of the cell stack body, and the method of manufacturing the fuel cell stack further comprising
a preparatory step of preparing a pair of the insulating plates each being provided with an end part resin seal member configured to be extended linearly,
wherein, in the stacking step, the pair of insulating plates and the cell stack body are stacked mutually on one another, in a manner so that the end surface in the protruding direction of the metal seal member of the end part metal separator, which is the metal separator positioned on an end part in the stacking direction of the cell stack body, contacts the end part resin seal member.

7. The method of manufacturing the fuel cell stack according to claim 6, wherein, in a state in which a tightening load is applied to the cell stack body, a dimension of the end part resin seal member in a widthwise direction of the end part resin seal member is greater than an interval between base portions of the metal seal member.

8. A method of manufacturing a fuel cell stack, the fuel cell stack including:
a cell stack body in which a plurality of electrical power generating cells are stacked mutually on one another, each of the electrical power generating cells including
a membrane electrode assembly in which electrodes are joined to both surfaces of an electrolyte membrane, and
a pair of metal separators disposed on both sides of the membrane electrode assembly and formed in a plate-like shape, and
a pair of insulating plates disposed on both sides in a stacking direction of the cell stack body,
wherein each of a pair of end part metal separators, which are the pair of metal separators positioned at both ends in the stacking direction of the cell stack body, includes a metal seal member configured to extend linearly together with projecting out toward the insulating plates, and to elastically deform by a clamping load being applied in the stacking direction to the cell stack body,
the method of manufacturing the fuel cell stack comprising:
a preparatory step of preparing a pair of insulating plates each of which is provided with an end part resin seal member configured to be extended linearly; and
a stacking step of mutually stacking the pair of insulating plates and the pair of end part metal separators, in a manner so that the end surfaces in a protruding direction of the metal seal member of the end part metal separators are in contact with the end part resin seal member.

9. A fuel cell stack comprising a cell stack body in which a plurality of electrical power generating cells are stacked mutually on one another,
wherein
the electrical power generating cells includes
a resin framed membrane electrode assembly including
a membrane electrode assembly in which electrodes are joined to both surfaces of an electrolyte membrane, and
a resin frame member disposed on an outer peripheral part of the membrane electrode assembly in a manner so as to project outwardly from the outer peripheral part of the membrane electrode assembly, and
a pair of metal separators disposed on both sides of the resin framed membrane electrode assembly and formed in a plate-like shape,
each of the pair of metal separators includes a metal seal member configured to extend linearly together with projecting out toward the resin frame member, and to elastically deform by a clamping load being applied in a stacking direction to the cell stack body,
the resin framed membrane electrode assembly includes a resin seal member provided on both sides of the resin frame member, and configured to be extended linearly together with being in contact with an end surface in a protruding direction of the metal seal member, and
a dimension of the resin seal member in a widthwise direction of the resin seal member is greater than an interval between base portions of the metal seal member.
